(19) United States
(12) Patent Application Publication
(10) Pub. No.: US 2026/0032604 A1
(43) Pub. Date: Jan. 29, 2026

(54) WIRELESS LINK CONTROL BASED ON BANDWIDTH CONDITIONS

(71) Applicant: Charter Communications Operating, LLC, St. Louis, MO (US)

(72) Inventors: Pareshkumar Panchal, Highlands Ranch, CO (US); Muhib Taiye Oduwaiye, Aurora, CO (US)

(21) Appl. No.: 18/787,230

(22) Filed: Jul. 29, 2024

(51) Int. Cl. H04W 52/34; H04W 52/28; H04W 52/36

(52) U.S. Cl. CPC H04W 52/343; H04W 52/28; H04W 52/367

(57) ABSTRACT

A wireless system as discussed herein includes a communication management resource configured to receive a message associated with usage of wireless bandwidth allocated for use by multiple wireless stations (such as a first wireless station and the second wireless station) communicating with each other in a network environment. In response to receiving the message, the communication management resource controls a power level of the first wireless station wirelessly transmitting communications to the second wireless station in the network environment. The power level can be controlled under different circumstances (such as increase in the magnitude of the wireless bandwidth, decrease in the magnitude of the wireless bandwidth, detection of interference, etc.) to maintain wireless connectivity between the first wireless station and the second wireless station.

### BACKGROUND

A conventional CBRS (Citizens Broadband Radio Service) network implements up to 150 MHz of spectrum in the 3550 MHz to 3700 MHz range (3.5 GHz to 3.7 GHz) that the Federal Communications Commission (FCC) has designated for sharing among three tiers of users: incumbent users, priority access license (PAL) users and general authorized access (GAA) users.

Conventional radio network planning is often based on use of a combination of PAL and GAA wireless channels. For example, in a geographic area, two PAL channels (2×10 MHz: 20 MHz) and 2 GAA channels (2×10MHz: 20 MHz) may be used for network planning. Once the network is deployed, it is likely that GAA channels may already be in use by the wireless base station, the channels may not belong to any specific carriers (operator). Network planning may be done with the use of link budget where specific parameters such as transmit power, sensitivity, noise factor, modulation scheme, cell edge scenario, required data rate, and other margins are considered.

### BRIEF DESCRIPTION OF EXAMPLES

Techniques herein include providing transmit power control such as in an uplink direction and a downlink direction to support better use of available wireless resources.

More specifically, as discussed herein, a communication management resource can be configured to receive a message associated with usage of wireless bandwidth currently allocated for use by multiple wireless stations communicating with each other in a network environment. Assume that the multiple wireless stations include a first wireless station and a second wireless station. In response to receiving the message, the communication management resource can be configured to control a power level of the first wireless station wirelessly transmitting communications to the second wireless station in the network environment. The wireless power level may be controlled at sufficient levels to maintain wireless connectivity between the first wireless station and the second wireless station.

In accordance with further examples as discussed herein, the message received by the communication management resource is a control notification indicating reduction in the wireless bandwidth allocated for use by the multiple wireless stations in the network environment. Controlling the power level of the first wireless station may include the communication management resource transmitting a control command from the second wireless station to the first wireless station. The transmitted control command can be configured to notify the first wireless station to increase the power level of the first wireless station wirelessly transmitting communications to the first wireless station in response to the reduction in the wireless bandwidth used by the first wireless station to wirelessly transmit data to the second wireless station. In one example, the increased power level of wireless transmitting the communications at the reduced allocated wireless bandwidth enables the first wireless station to maintain connectivity with the wireless base station 131.

Still further, the second wireless station may be a wireless base station; the first wireless station may be a mobile communication device in communication with the wireless base station via the wireless connectivity.

In accordance with yet another example, control of the power level of the first wireless station may occur in response to detecting a condition in which the first wireless station resides at an edge of a region of wireless coverage supported by the second wireless station. As previously discussed, the message can be generated to indicate reduced wireless bandwidth allocated for use by the multiple wireless stations. Controlling the transmit power level of the first wireless station may include the communication management resource or other suitable entity increasing a magnitude of the power level of the first wireless station wirelessly transmitting communications to the second wireless station to maintain a respective wireless data rate between the first wireless station and the second wireless station even though bandwidth is decreased. The increased magnitude (counteracting effects of the reduction of wireless bandwidth) ensures that the wirelessly transmitted communications from the first wireless station at the reduced bandwidth are received by the second wireless station.

Yet further, controlling the power level of the first wireless station wirelessly transmitting the communications may include the communication management resource: receiving feedback indicating a quality of wireless messages conveyed between the first wireless station and the second wireless station; and iteratively controlling (such as increasing) the power level of the first wireless station wirelessly transmitting the communications to the second wireless station based on the feedback.

As further discussed herein, note that the message received by the communication management resource may indicate detection of wireless interference associated with use of the wireless bandwidth allocated for use by the multiple wireless stations.

In one example, the message received by the communication management resource indicates detection of wireless interference to an entity having higher priority rights associated with use of the wireless bandwidth allocated to the multiple wireless stations. Controlling the power level of the first wireless station may include reducing a magnitude of the power level of the first wireless station or the second wireless station transmitting wireless signals in response to receiving the message. Transmission of the communications from the first wireless station to the second wireless station such as at the reduced magnitude of power level may be sufficiently high to maintain the wireless connectivity between the first wireless station and the second wireless station. Transmission of the communications from the first wireless station to the second wireless station at the reduced magnitude of power level may also reduce wireless interference to the entity having the higher priority rights.

Yet further, the first wireless station may be a wireless base station; the second wireless station may be a first mobile communication device. The first mobile communication device may be one of multiple mobile communication devices in wireless communication with the wireless base station.

In another example, the message as discussed herein is a control notification indicating an increase in the wireless bandwidth allocated for use by the multiple wireless stations in the network environment. Controlling the power level of the first wireless station may include the communication management resource transmitting a control command from the second wireless station to the first wireless station. The transmitted control command can be configured to notify the first wireless station to decrease the power level of the first wireless station wirelessly transmitting communications to the first wireless station in response to the increase in the wireless bandwidth.

Techniques as discussed herein are useful over conventional techniques. For example, one or more implementation of a communication management resource and corresponding operations as discussed herein provide better use of a respective wireless network to more efficiently convey data.

Note that any of the resources as discussed herein can include one or more computerized devices, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including a non-transitory computer-readable storage medium or any computer readable hardware storage medium on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, examples herein are also directed to a method, system, computer program product, etc., that supports operations as discussed herein.

One example as further discussed herein includes a computer readable storage medium and/or system having instructions stored thereon. The instructions, when executed by the computer processor hardware, cause the computer processor hardware (such as one or more co-located or disparately processor devices or hardware) to: receive a message associated with usage of wireless bandwidth allocated to multiple wireless stations communicating with each other in a network environment, the multiple wireless stations including a first wireless station and a second wireless station; and in response to receiving the message, control a power level of the first wireless station wirelessly transmitting communications (such as at the newly assigned lower bandwidth) to the second wireless station in the network environment, the power level controlled to maintain wireless connectivity between the first wireless station and the second wireless station.

The ordering of the steps above has been added for clarity sake. Note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing wireless connectivity in a network environment. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more inventive concepts as described herein can be implemented and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a wireless network environment and implementation of one or more wireless access points providing multiple different communication devices wireless connectivity to a remote network as discussed herein.

FIG. 2 is an example diagram illustrating implementation of a bandwidth change and corresponding regions of wireless coverage as discussed herein.

FIG. 3 is an example diagram illustrating implementation of a bandwidth change and corresponding regions of wireless coverage as discussed herein.

FIG. 4 is an example diagram illustrating a change in wireless power levels associated with an uplink at different bandwidth as discussed herein.

FIG. 5 is an example diagram illustrating different network resources supporting wireless power level control as discussed herein.

FIG. 6 is an example timing diagram illustrating communications amongst multiple network resources to implement wireless power control in an uplink direction as discussed herein.

FIG. 7 is an example diagram illustrating example computer hardware and software operable to execute operations as discussed herein.

FIG. 8 is an example diagram illustrating a method as discussed herein.

FIG. 9 is an example diagram illustrating detection of wireless channel usage in a protected zone and corresponding power control as discussed herein.

FIG. 10 is an example diagram illustrating power control of a base station wirelessly transmitting in the downlink direction in response to detecting wireless channel interference as discussed herein.

FIG. 11 is an example diagram illustrating wireless power control of a mobile communication device wirelessly transmitting in an uplink direction in response to detecting wireless channel interference as discussed herein.

The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DESCRIPTION OF EXAMPLES

A wireless system as discussed herein includes a communication management resource configured to receive a message associated with wireless bandwidth allocated for use by multiple wireless stations (such as a first wireless station and the second wireless station) communicating with each other in a network environment. The message may indicate any suitable events such as a change in allocated wireless bandwidth, occurrence of wireless interference, and so on. In response to receiving the message, and corresponding notification of one or more events or network conditions as indicated by the message, the communication management resource controls a power level of the first wireless station wirelessly transmitting communications to the second wireless station in the network environment. The power level can be controlled under different detected circumstances (such as increase in the magnitude of the wireless bandwidth, decrease in the magnitude of the wireless bandwidth, detection of interference, failure to detect interference, etc.) to maintain wireless connectivity and data rate between the first wireless station and the second wireless station. Additionally, or alternatively, the receipt of the message may prompt the second wireless station to adjust its wireless transmit power level when transmitting communications to the first wireless station

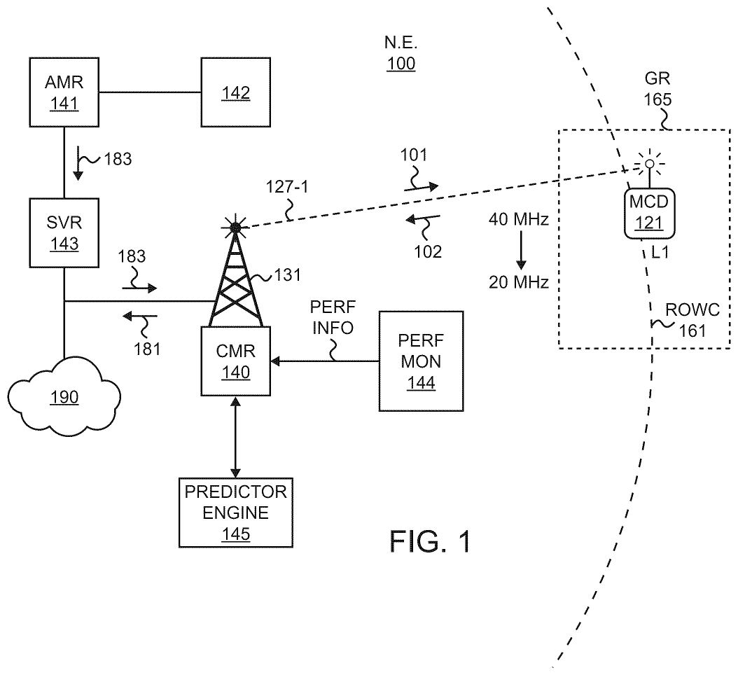

Now, more specifically, FIG. 1 is an example diagram illustrating a network environment and implementation of one or more wireless access points to provide multiple different communication devices connectivity to a remote network as discussed herein.

As shown in FIG. 1, the network environment 100 includes allocation management resource 141, monitor resource 142 (such as including environmental sensing capability), server 143, base station 131 (second wireless station), communication management resource 140, performance monitor 144, prediction engine 145, and mobile communication device 121 (first wireless station).

Note that the resources as discussed herein can be implemented in any suitable manner. For example, the allocation management resource 141 can be configured as allocation management hardware, allocation management software, or a combination of allocation management hardware and allocation management software; the monitor resource 142 can be implemented as monitor hardware, monitor software, or a combination of monitor hardware and monitor software; server 143 can be implemented as server hardware, server software, or a combination of server hardware and server software; communication management resource 140 can be implemented as communication management hardware, communication management software, or a combination of communication management hardware and communication management software; performance monitor 144 can be implemented as performance monitor hardware, performance monitor software, or a combination of performance monitor hardware and performance monitor software; prediction engine 145 can be implemented as prediction engine hardware, prediction engine software, or a combination of prediction engine hardware and prediction engine software; mobile communication device 121 can be implemented as hardware, software, or a combination of hardware and software; and so on.

The network environment 100 can include any number of mobile communication devices in communication with the network 190 through the wireless base station 131.

As its name suggests, the communication management resource 140 provides management of wireless communications in the network environment 100. In this example, the mobile communication device 121 establishes a respective wireless communication link 127-1 with the wireless base station 131. As previously discussed, the wireless base station 131 provides the mobile communication device 121 wireless connectivity (wireless communication link 127-1) to the wireless base station 131 and through the wireless base station 131 to the network 190.

In one example, the wireless base station 131 and corresponding communication management resource 140 are allocated one or more wireless channels for communicating with one or more communication devices in the network environment 100 based upon allocation communications received from the allocation management resource 141.

More specifically, in this example, the communication management resource transmits communications 181 to the allocation management resource 141 for allocation of bandwidth. In response to the request for allocation of one or more channels, assume that the allocation management resource 141 allocates the wireless base station 131 and corresponding communication device 121 (and potentially other mobile communication devices in the network environment 100) use of wireless channel #1, channel #2, channel #3, and channel #4. Assume further that this amounts to 40 megahertz of bandwidth because each channel represents 10 megahertz of bandwidth.

Note that the wireless channels can be allocated from any suitable wireless spectrum. In one example, the wireless channels are allocated from a CBRS (Citizen Band Radio Service) in which each wireless channel is 10 megahertz. In such an instance, the wireless base station 131 is allocated a bandwidth of 40 megahertz as previously discussed.

As further shown, the monitor resource 142 in the network environment 100 monitors for use of wireless channels by an incumbent entity having higher priority use of wireless channels than wireless base station 131 or the mobile communication device 121. When no incumbent entity is detected by the monitor resource 142, the communication management resource 140 and corresponding mobile communication device 121 are able to continue communicate over the wireless communication link 127-1 using the allocated wireless channel #1, channel #2, channel 3, and channel #4.

In a further example, assume that the monitor resource 142 detects use of wireless channel #3 and wireless channel #4 by an incumbent entity having higher priority rights than the wireless base station 131 and the communication device 121. In such an instance, in response to detection of the incumbent entity using the wireless channel #3 and wireless channel #4, the allocation management resource 141 revokes (suspends) use of the wireless channel #3 and wireless channel #4 by the wireless base station 131 and the communication device 121.

In one example, via the allocated 40 megahertz bandwidth, the wireless base station 131 communicates over the wireless communication link 127-1 at a first data rate. It is desirable to continue to provide the mobile communication device 121 the first data rate even after the 40 megahertz bandwidth is reduced to 20 megahertz. Revocation of the 40 megahertz bandwidth to 20 megahertz includes the allocation management resource 141 providing notification to the server 143 and conveyance of a respective message 183 (such as an allocation message) through the server 143 to the communication management resource 140 and corresponding wireless base station 131. The communication management resource 140 can be configured to generate communications 181 requesting allocation of wireless channels. The communication management resource 140 communicates the request to server 143.

In a reverse direction, the wireless base station 131 and corresponding communication management resource 140 receive a message (such as communications 183) associated with usage of current wireless bandwidth (40 megahertz) allocated for use by multiple wireless stations communicating (wireless base station 131 and mobile communication device 121) with each other in a network environment 100.

In one example, as previously discussed, the message received from the allocation management resource 141 indicates revocation of wireless channel #3 wireless channel #4. In such an instance, the wireless base station 131 and corresponding mobile communication device 121 are notified (such as via the communications 183) to discontinue using wireless channel #3 and wireless channel #4 and continue using wireless channel #1 and wireless channel #2 (20 megahertz of wireless bandwidth).

As further discussed herein, in response to receiving the revocation message, via commands such as transmitted in communications 101 to the mobile communication device 121, the communication management resource 140 and corresponding wireless base station 131 control a power level of the first wireless station (mobile communication device 121) wirelessly transmitting communications 102 to the second wireless station (wireless base station 131) to maintain the first data rate. In other words, because there is a reduction in wireless bandwidth from 40 megahertz to 20 megahertz, the wireless base station 131 adjusts a magnitude of wireless signals (using the newly allocated bandwidth of 20 megahertz) transmitted in the uplink direction to the wireless base station 131 to continue to support the first data rate between the wireless base station 131 and the mobile communication device 121 over the wireless communication link 127-1 using the 20 megahertz bandwidth.

Thus, the wireless transmit power level of the mobile communication device 121 is controlled by the communication management resource 140 to maintain wireless connectivity (such as wireless communication link 127-1) between the mobile communication device 121 and the wireless base station 131 and continue to support the first data rate of communicating bits of information or the wireless communication link 127-1 from the wireless base station 131 to the mobile communication device 121. In such an instance, via higher wireless transmit power level, the mobile communication device 121 is afforded the same data rate of data conveyance over the wireless communication link 127-1 even though bandwidth was reduced from 40 megahertz to 20 megahertz.

In accordance with further examples as discussed herein, the message (received in communications 183) is a control notification indicating reduction in a magnitude of the current wireless bandwidth allocated for use by the multiple wireless stations in the network environment.

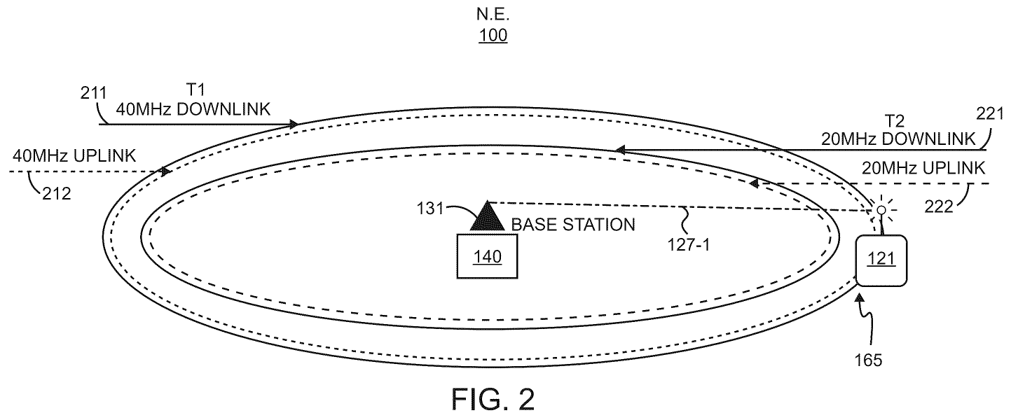

Wireless bandwidth revocation by the allocation management resource 141 in this example includes reduction in the 40 megahertz of wireless bandwidth to 20 megahertz of wireless bandwidth. The effect of reducing the bandwidth is further shown and discussed in FIG. 2.

FIG. 2 is an example diagram illustrating implementation of first bandwidth such as 40 megahertz and transition to implementation of a second bandwidth such as 20 megahertz and resulting regions of wireless coverage as discussed herein.

As previously discussed, the allocation management resource 141 can be configured to allocate 40 megahertz of bandwidth for use by the wireless base station 131 and the mobile communication device 121 at or around time T1 prior to the reduction. FIG. 2 illustrates a corresponding downlink region of wireless coverage 211 associated with allocation of the 40 megahertz of bandwidth for use by the wireless base station 131. The downlink region of wireless coverage 211 represents a distance from the wireless base station where the mobile communication device 121 is still able to receive wireless signals from the wireless base station 131. The uplink region of wireless coverage 212 represents a range associated with the 40 megahertz of wireless bandwidth in which the mobile communication device 121 is able to communicate (such as the transmitting at power P1) in the uplink to the wireless base station 131.

As further shown in FIG. 2, the reduction in the wireless bandwidth from 40 megahertz to 20 megahertz at time T2 results in a smaller region of wireless coverage (or different sized region compared to the region of wireless coverage provided by the 40 megahertz setting) for the downlink communications from the wireless base station 131 to the mobile communication device for a given data rate such as the first data rate. For example, the downlink region of wireless coverage 221 is associated with allocation of the 20 megahertz of bandwidth for use by the wireless base station 131. The downlink region of wireless coverage 221 represents a distance from the wireless base station 131 where the mobile communication device 121 is still able to receive wireless signals for the first data rate from the wireless base station 131 for the allocated 20 megahertz of bandwidth (such as wireless channel #1 that wireless channel #2). Based on the reduced bandwidth, the mobile communication device 121 is no longer able to receive wireless signals from the wireless base station 131 at the first data rate. The uplink region of wireless coverage 222 represents a range associated with the 20 megahertz of wireless bandwidth in which the mobile communication device 121 is able to communicate in the uplink such as at power PI to the wireless base station 131 (such as wireless channel #1 and wireless channel #2).

It is noted that the mobile communication device 121 resides in a geographical region 165 at an edge of the region of wireless coverage 211 (outer ring). The reallocation of the 20 megahertz of bandwidth places a burden on the mobile communication device 121 communicating in the uplink direction from the mobile communication device 121 to the wireless base station 131. In other words, the mobile communication device 121 was previously able to communicate at the wireless power level P1 to transmit data from the mobile communication device 121 to the wireless base station 131 via use of 40 megahertz bandwidth for a given data rate (such as a first data rate). The reduction in the magnitude of the allocated wireless bandwidth from 40 megahertz to 20 megahertz now makes it difficult if not impossible for the mobile communication device 121 to transmit corresponding data communications at the first data rate in the uplink direction over the wireless communication link 127-1 to the wireless base station 131 because of the decreased region of wireless coverage for uplink (222) and downlink communications (221).

Further in this example, via communications 101, assume that the wireless base station 131 transmits a control command to the mobile communication device 121. To address the issue of mobile communication device 121 now being outside of the region of wireless coverage (222) in the uplink direction, the transmitted control command from the wireless base station 131 and the corresponding communication management resource 140 notifies the mobile communication device 121 to increase the power level (such as increase power to wireless transmit power level from P1 to P2, where power level P2 is greater than power level P1) of the mobile communication device 121 wirelessly transmitting communications 102 (at the 20 megahertz bandwidth) to the wireless base station 131 in response to the reduction in the wireless bandwidth at time T2. The increased power level enables the mobile communication device 121 to communicate with the wireless base station 131 at the first data rate using the allocated 20 megahertz.

As further discussed herein, the communication management resource 140 corresponding wireless base station 131 can be configured to control (increase the transmit power level from PI to wireless level P2) the power level of the first wireless station occurs in response to detecting a condition in which the mobile communication device 121 resides in the geographical region 165, which is an edge of a region of wireless coverage supported by the wireless base station 131 or the mobile communication device 121. The notification of and the implementation of the increased magnitude of transmitting wireless communications from the mobile communication device 121 to the wireless base station 131 ensures that the wirelessly transmitted communications (at the reduced 20 megahertz bandwidth) from the mobile communication device 121 are received by the wireless base station 131.

As further discussed herein, note that the allocation management resource 141 can be configured to generate the communications 183 to include a control notification indicating an increase in the wireless bandwidth allocated for use by the multiple wireless stations in the network environment. In such an instance, controlling the power level of the communication device 121 includes the communication management resource 140 and corresponding wireless base station 131 transmitting a control command or multiple commands to the communication device 121. For the increased bandwidth, the transmitted one or more control commands notify the mobile communication device 121 to decrease the power level of the first wireless station wirelessly transmitting communications to the first wireless station in response to the increase in the wireless bandwidth.

Thus, typically, cell edge coverage thresholds may be determined based on link budget with limited pathloss scenario (uplink or downlink). In such an instance, this means, for any given requirement on cell edge data rate, path loss which is minimum will decide the coverage radius and network design objectives.

As shown in the illustration in FIG. 2, the 40 MHz wireless radio coverage is greater than the 20 MHz radio wireless radio coverage for a given data rate requirement (such as the first data rate), which could be due to multiple reasons such as vendor inputs, link budget criterion, simulations, assumptions etc.

This example further illustrates that the wireless base station 131 transmitting 40 MHz vs 20 MHz carrier bandwidth will have different coverage areas for specific data rate assumptions. Note that the presence of the mobile communication device 121 at the edge (165) of the region of wireless coverage 211 or region of wireless coverage 212 doesn't prevent the mobile communication device and corresponding user from using the wireless base station 131 to access the network 190.

In the situation of FIG. 2, if the network was designed at 10 Mbps downlink and 2 Mbps uplink data rate requirements, users in the network environment of FIG. 2 (difference of 20 MHz and 40 MHz), will have poor coverage or at least different wireless coverage, which may prevent those devices and corresponding users from being able to use the wireless services associated with the wireless base station 131. Since the wireless base station 131 may be disposed at a fixed location, moving the wireless base station 131 may not be an option. Cell edge coverage area depends on radio vendor equipment, offered data rate for UL (Uplink) or DL (Downlink) and other such factors impacting the coverage.

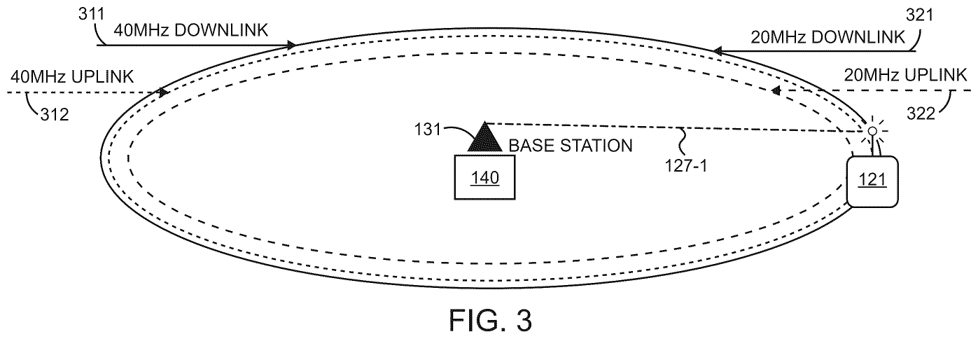

FIG. 3 is an example diagram illustrating implementation of first bandwidth such as 40 megahertz in transition to a second bandwidth such as 20 megahertz and resulting regions of wireless coverage as discussed herein.

In this example as shown in FIG. 3, the region of wireless coverage 311 associated with the downlink communications from the wireless base station 131 to a respective mobile communication device and the region of wireless coverage 321 associated with downlink communications from the wireless base station 131 to a respective mobile communication device are substantially equal. However, in a similar manner as previously discussed, the region of wireless coverage 322 associated with the reduced wireless bandwidth of 20 megahertz in the uplink to the wireless base station 131 is smaller than the uplink region of wireless coverage 312 provided by the initial allocated wireless bandwidth of 40 megahertz.

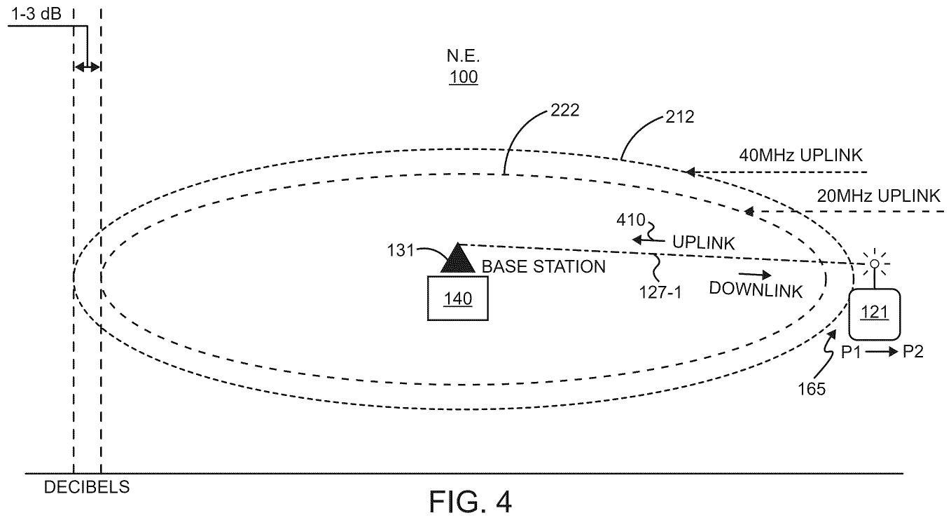

FIG. 4 is an example diagram illustrating a change in wireless power levels associated with an uplink as discussed herein. In this example, the communication device 121 resides in or at the geographical region 165 (or geographical location such as edge of the region of wireless coverage). Transmitting wireless signals (such as using the 40 megahertz bandwidth) from the mobile communication device 121 at the power level P1 on the edge of the region of wireless coverage 212 ensures that the mobile communication device 121 is able to communicate with the wireless base station 131 for a specific data rate requirement such as a first data rate. Transmission of wireless signals (such as using the 40 megahertz bandwidth for the first data rate) from the mobile communication device 121 at wireless power level P1 are received by the wireless base station 131 while the mobile communication device 121 resides on the edge of the region of wireless coverage 212.

However, transmission of wireless communications (using the allocated 20 megahertz and first data rate) from the mobile communication device 121 at wireless power level P1 are too low for receipt of those communications (such as at the first data rate) via the wireless base station 131. As previously discussed, techniques herein include increasing the corresponding wireless power level (transition from wireless power level P1 to wireless power level P2) such that corresponding wireless communications (using the 20 megahertz bandwidth and transmitting at the first data rate) transmitted from the communication device 121 (outside of region of wireless coverage 222) at power level P2 are received by the wireless base station 131.

As further shown in FIG. 4, the allocation of the reduced bandwidth to the wireless base station 131 and the corresponding mobile communication device 121 results in a 1 to 3 decibel level drop in the wireless signals 410 transmitted from the mobile communication device 121 to the wireless base station 131 in the uplink direction when the communication device 121 transmits at a given power level. As previously discussed, this means that the communication device 121 needs to wirelessly transmit at a higher power level while at geographical region 165 (location) when using the 20 megahertz uplink allocation.

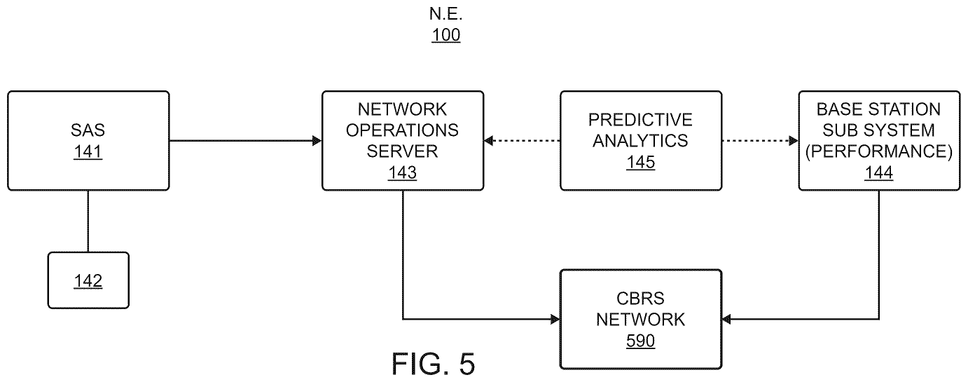

FIG. 5 is an example diagram illustrating a network resources supporting wireless power level control as discussed herein. As a

As previously discussed, the network environment 100 can be configured to include allocation management resource 141, monitor resource 142, server 143, predictive engine 145, performance monitor 144, and corresponding network 590 including wireless base station 131 and mobile communication device 121.

Further, as previously discussed, the allocation management resource 141 may be cloud-based. In general, the allocation management resource 141 monitors feedback from the monitor resource 142 indicating whether or not a respective incumbent entity or other entity is using any of one or more protected wireless channels. The allocation management resource 141 grants or revokes use of respective wireless channels as per the rules set by a regulatory authority defining a respective tiered hierarchy where the incumbent entity has the highest priority rights in use of wireless channels; the wireless base station and communication device have lower priority rights to use the wireless channels with respect to the incumbent entity.

The server 143 such as a network operations server or other suitable entity supports communication with CBSDs (such as wireless base stations) as well as external entities such as the allocation management resource 141 or other network servers. The server 143 can be configured to communicate or adjust all relevant parameters. The server 143 also can be configured to monitor configuration management capabilities.

The performance monitor 144 such as Base Station Sub System or other suitable entity supports monitoring of wireless communication performance in the network environment 100. The performance monitor 144 can be configured to implement all the counters or KPIs (Key Performance Information) needed to monitor the network. The performance monitor 144 can be configured to provide feedback associated with the performance to network operations server 143 based on performance impact as per configuration modification.

As its name suggests, the prediction engine 145 implements a predictive analytics function operative to receive and store information about the radio simulation input along with link budget specifications from a respective vendor operating the wireless base station 131. The prediction engine 145 can be configured to communicate with the server 143 such as Network operations server and the performance monitor 144 such as a base station performance monitoring system.

In one example, the prediction engine and corresponding executed predictive analytics function can be configured to produce 5 meter×5 meter or 10 meter×10 meter or other suitable sized bin areas (geographical regions) of wireless coverage (different regions of wireless coverage) for each of the 20 MHz bandwidth allocation, 40 megahertz bandwidth allocation, or any combination of wireless channels.

In a further example, a predictive analytics function implemented by the prediction engine 145 can be configured to produce so-called power control zones, indicating which of the mobile communication devices in the network environment 100 are disposed on a respective edge of a region of wireless coverage. Those identified mobile communication devices at edge of the region of wireless coverages are candidates for power control as discussed herein during conditions in which there is a change in allocated wireless bandwidth.

Note further that the predictive analytics function can be configured to measure the differential pathloss in each pixel or area or geographical region. In many cases, there may be a 1-3 dB (decibel) difference when communicating from the mobile communication device at a given power level for different wireless bandwidths. As discussed herein, the communication management resource 140 increases the magnitude of the wireless transmit power of one or more molestation to accommodate the smaller region of wireless coverage 222 associated with the reduction to the 20 megahertz bandwidth.

If desired, the allocation management resource 141 can be configured to notify the server 143 with information regarding changes in a magnitude of allocated wireless bandwidth such as from 40 megahertz to 20 megahertz or an increase in wireless bandwidth from 20 megahertz to 40 megahertz. The allocation management resource 141 or other suitable entity can be configured to detect so-called power control zones where mobile communication devices 121 residing in the network environment 100 require power control as discussed herein to ensure that they are still able to communicate on the uplink to the wireless base station 131.

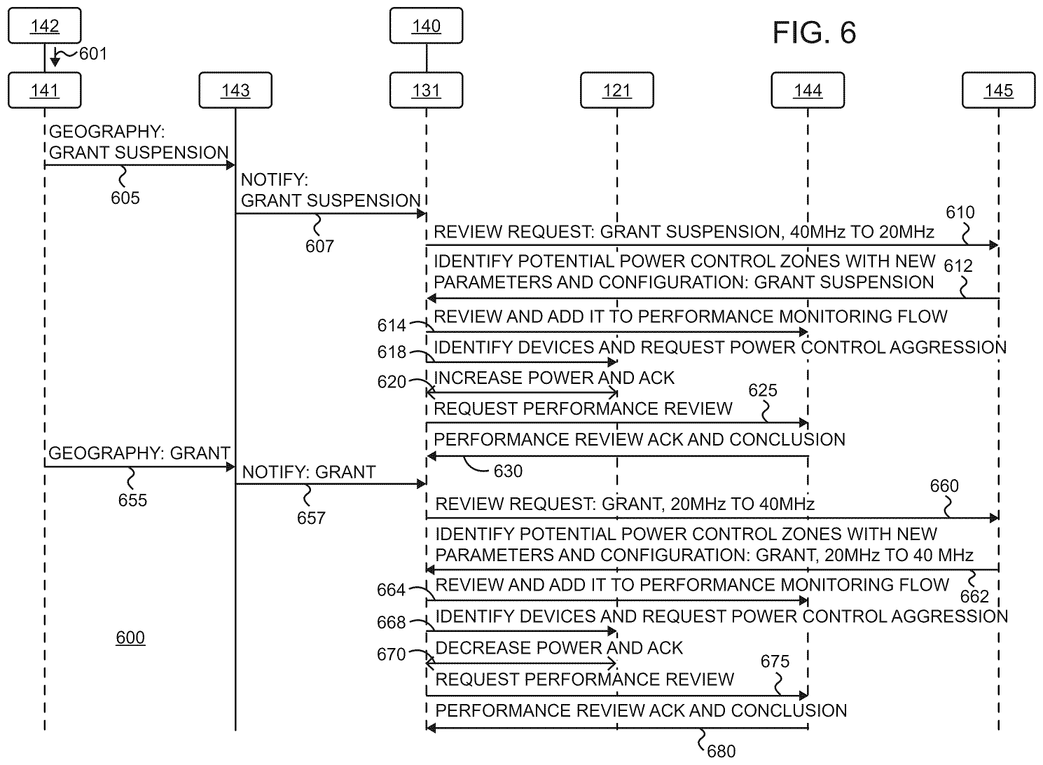

FIG. 6 is an example timing diagram illustrating communications amongst multiple network resources to implement wireless power control in an uplink direction as discussed herein.

More specifically, timing diagram 600 in FIG. 6 illustrates uplink power control adjustments based upon detecting revocation of wireless bandwidth or grant of wireless bandwidth to the network 590 including the wireless base station 131 and the mobile communication device 121 as discussed herein.

In this example, assume that the wireless base station 131 and corresponding mobile communication device 121 are initially allocated use of 40 megahertz of wireless bandwidth such as including wireless channel #1, wireless channel #2, wireless channel #3, and wireless channel #4. The wireless base station 131 and the corresponding mobile communication device 121 use the allocated wireless channels to convey data in both directions over the wireless communication link 127-1 between the wireless stations.

Assume further that the monitor resource 142 transmits the communications 601 to the allocation management resource 140 in response to detecting that an incumbent entity is currently using wireless channel #3 and wireless channel #4. The communications 601 can be configured to indicate that the incumbent entity is currently using wireless channel #3 and wireless channel #4.

Receipt of the communications 601 prompts the allocation management resource 141 to revoke allocation of corresponding wireless channel #3 and wireless channel #4, while still allocating wireless channel #1 and wireless channel #2 for use by the wireless base station 131 and the mobile communication device 121. For example, in response to receiving the communications 601, the allocation management resource 141 transmits communications 605 to the server 143. The communications 605 notify the server 143 of the revocation of wireless channel #3 and wireless channel #4 and continued allocation of the wireless channel #1 and wireless channel #2 to the wireless base station 131. In other words, the server 143 receives notification that wireless bandwidth allocated to the wireless base station 131 has been reduced from 40 megahertz to 20 megahertz.

As further shown, in response to receiving the communications 605 and revocation of wireless channel #3 and wireless channel #4, the server 143 transmits communications 607 (grant suspension) to the wireless base station 131 and corresponding communication management resource 140. The communications 607 notify the wireless base station 131 and corresponding communication management resource 140 that wireless channel #3 and wireless channel #4 are being revoked while wireless channel #1 and wireless channel #2 are still allocated for use by the wireless base station 131 and mobile communication device 121.

Note that each of the wireless channels #1, #2, #3, and #4, can be any suitable type of channels. In one example, each of the one or more of the wireless channels is a so-called GAA (General Authorized Access) wireless channel in a CBRS (Citizen Band Radio Service) system. Alternatively, each of the one or more wireless channels may be a PAL (Priority Access License) channel in a CBRS system. Any combination of different types of channel allocation is possible.

In response to receiving communications 607 indicating suspension (that is, revocation) of use of wireless channel #3 and wireless channel 4, the wireless base station 131 transmits communications 610 to the prediction engine 145 implementing a respective predictive analytics function. The communications 607 include a request to review the revocation of the wireless channels #3 and #4.

In response to receiving the communications 610 indicating notice of revocation change in bandwidth and review request, the prediction engine 145 generates and transmits communications 612 to the wireless base station 131 and corresponding communication management resource 140. The communications 612 can be configured to indicate power control zones (such as specifying geographical region 165 and other geographical regions) indicating where one or more mobile communication devices are susceptible to being unable to wirelessly communicate in an uplink direction to the wireless base station 131 if they do not increase their wireless transmit power of transmitting corresponding wireless communications (such as at the reduced wireless bandwidth). In this example, the communications 612 indicate that the geographical region 165 and/or mobile communication device 121 reside in a so-called power control zone needing power control adjustments to ensure that the mobile communication device 121 is able to continue to communicate in the uplink over the wireless communication link 127-1 after revocation of wireless channel #3 and wireless channel #4 (for example, just using the reduced bandwidth of 20 megahertz).

The wireless base station 131 and corresponding communication management resource 140 determine and review the identity of one or more mobile communication devices and/or the one or more geographical regions as specified by the communications 612. In this example, the communication management resource 140 determines (such as because the mobile communication device 121 resides in the geographical region 165) that the mobile communication device 121 resides on a corresponding edge of a region of wireless coverage associated with the wireless base station 131. As further discussed below, because the mobile communication device 121 resides on a corresponding edge of the region of wireless coverage, the wireless base station 131 and corresponding communication management resource notify the mobile communication device 121 to increase its power level when wirelessly transmitting signals at the 20 megahertz bandwidth.

Note that the wireless base station 131 and corresponding communication management resource 140 can be configured to determine the location of the mobile communication device 121 in any suitable manner. For example, the mobile communication device 121 can be configured to indicate its location to the wireless base station 131 over the wireless communication link 127-1.

As further shown, the wireless base station 131 and corresponding communication management resource 140 transmit communications 614 to the performance monitor 144 after determining that the mobile communication device 121 resides in a so-called power control zone and may be unable to communicate over a respective uplink at a specific data rate such as the first data rate with the wireless base station 131 because the allocated wireless bandwidth was reduced from 40 megahertz to 20 megahertz.

In response to receiving the communications 614, the performance monitor 144 monitors communications between the mobile communication device 121 and the wireless base station 131. Based on the monitoring, the performance monitor 144 produces performance information associated with the communications conveyed between the wireless base station 131 and the mobile communication device 121. The performance information indicates the quality of the wireless communication link 127-1 and how well it supports conveyance of data.

As further shown, the wireless base station 131 and corresponding communication management resource 140 transmit one or more commands in the communications 618 to the mobile communication device 121. The one or more commands notify the mobile communication device 121 to increase a magnitude of the wireless power of transmitting communications 102 from the mobile communication device 121 to the wireless base station 131 from a wireless transmit power level of P1 (associated with the prior allocated 40 megahertz bandwidth) to a wireless transmit power level of P2 (associated with the newly allocated 20 megahertz bandwidth, reduced bandwidth), where P2 is greater than P1.

In other words, in response to the revocation of wireless channel #3 and wireless channel #4, the communication management resource 140 and corresponding wireless base station 131 notify the mobile communication device 121 to transmit the communications 102 over the wireless channels #1 and #2 at the higher power level P2 to ensure that the wireless communications 102 are properly received by the wireless base station 131.

In response to receiving the communications 618, the mobile communication device 121 increases a respective power of transmitting communications 102 (using wireless channel #1 and wireless channel #2) over the wireless communication link 127-1 to the wireless base station 131.

Via communications 620, the mobile communication device 121 notifies the wireless base station 131 and corresponding communication management resource 140 of the increase in power associated with the mobile communication device 131 transmitting communications 102 in the uplink direction to the wireless base station 131. After receiving the acknowledgment that the mobile communication device 121 increased the wireless power level to power level P2 or at least a power greater than power level P1, the wireless base station 131 can be configured to notify the mobile communication device 121 that the wireless base station 131 receives the acknowledgment of the mobile communication device 121 increasing its power level to power level P2 or other suitable power setting greater than P1 and less than or equal to P2. As previously discussed, the increased wireless power level of the mobile communication device 121 transmitting over the wireless communication link 127-1 to the wireless base station 131 ensures that the mobile communication device 121 is able to communicate at the first data rate even though there is a bandwidth reduction from 40 megahertz to 20 megahertz.

Note that the process of the mobile communication device 121 increasing its wireless power output level to transmit the communications 102 may include multiple steps or operations where the mobile communication device 121 increases the respective power level of transmitting communications 102 step-by-step until the wireless base station 131 provides notification in the reverse direction to the mobile communication device 121 that the wireless base station 131 receives the wireless communications from the mobile communication device 121 at a sufficiently high wireless power level for the specific required data rate such as the first data rate.

As further shown, the wireless base station 131 and corresponding communication management resource 140 can be configured to transmit communications 625 to the performance monitor 144. In one example, the communications 625 include a request for review of performance information associated with the mobile communication device 121 transmitting at the new power level P2 to the wireless base station 131 using wireless channel #1 and wireless channel #2.

In response to receiving the request in communications 625, the performance monitor 144 transmits communications 630 to the wireless base station 131 and corresponding communication management resource 140. In one example, the communications include a performance analysis and/or performance information associated with the mobile communication device 121 wirelessly communicating with the wireless base station 131. If desired, the received performance information can be used as a basis to further control uplink power of the communication device 121 wirelessly transmitting to the wireless base station 131.

This concludes transitioning from using the 40 megahertz bandwidth to 20 megahertz bandwidth.

Eventually, the allocation management resource 141 detects that the incumbent entity no longer uses the wireless channels #3 and #4 based upon feedback (signal 601) from the monitor resource 142 to the allocation management resource 141. In such an instance, the allocation management resource 141 reallocates use of the wireless channel #3 wireless channel #4 for use by the wireless base station 131 and the communication device 121.

As previously discussed, the wireless base station 131 and corresponding mobile communication device 121 were allocated use of 20 megahertz of wireless bandwidth such as including wireless channel #1, and wireless channel #2.

Receipt of the communications 601 in this example prompts the allocation management resource 141 to reallocate corresponding wireless channel #3 and wireless channel #4 to the wireless base station 131 and corresponding communication management resource 140, while still allocating wireless channel #1 and wireless channel #2 for use by the wireless base station 131 and the mobile communication device 121.

In response to receiving the communications 601, the allocation management resource 141 transmits communications 655 to the server 143. The communications 655 notify the server 143 of the reinstatement of wireless channel #3 and wireless channel #4 and continued allocation of the wireless channel #1 and wireless channel #2 to the wireless base station 131. In other words, the server 143 receives notification that bandwidth allocated to the wireless base station 131 has been increased from 20 megahertz to 40 megahertz.

As further shown, in response to receiving the communications 655 and reinstatement of allocation of wireless channel #3 and wireless channel #4, the server transmits communications 657 to the wireless base station 131 and corresponding communication management resource 140. The communications 657 notify the wireless base station 131 and corresponding communication management resource 140 that wireless channel #3 and wireless channel #4 are being allocated for its use while wireless channel #1 and wireless channel #2 are still allocated for use by the wireless base station 131 and mobile communication device 121.

In response to receiving communications 657 indicating the reallocation of use of wireless channel #3 and wireless channel 4, the wireless base station 131 transmits communications 660 to the prediction engine 145 implementing the predictive analytics function. The communications 657 include a request to review the reallocation of the wireless channels #3 and #4.

In response to receiving the communications 660 indicating notice of change in bandwidth, the prediction engine 145 generates and transmits communications 662 to the wireless base station 131 and corresponding communication management resource 140. The communications 662 can be configured to indicate power control zones (such as specifying geographical region 165) indicating where one or more mobile communication devices that may no longer need to transmit at the higher transit power P2. In this example, the communications 662 indicate that the geographical region 165 and/or mobile communication device 121 reside in a so-called power control zone needing power control adjustments in view of the increase in wireless bandwidth of 40 megahertz (i.e., 4 wireless channels).

The wireless base station 131 and corresponding communication management resource 140 review the identity of one or more mobile communication devices and/or the one or more geographical regions as specified by the communications 662. In this example, the communication management resource 140 determines (such as because the mobile communication device 121 resides in the geographical region 165) that the mobile communication device 121 resides on a corresponding edge of a region of wireless coverage associated with the wireless base station 131.

As previously discussed, note that the wireless base station 131 and corresponding communication management resource 140 can be configured to determine the location of the mobile communication device 121 in any suitable manner. For example, the mobile communication device 121 can be configured to indicate its location to the wireless base station 131 over the wireless communication link 127-1.

As further shown, the wireless base station 131 and corresponding communication management resource 140 transmit communications 664 to the performance monitor 144 after determining that the mobile communication device 121 resides in a so-called power control zone and no longer needs to transmit the high power level P2 because the wireless bandwidth was increased from 20 megahertz to 40 megahertz.

In response to receiving the communications 664, the performance monitor 144 monitors communications between the mobile communication device 121 and the wireless base station 131. Based on the monitoring, the performance monitor 144 produces performance information associated with the communications conveyed between the wireless base station 131 and the mobile communication device 121.

As further shown, the wireless base station 131 and corresponding communication management resource 140 transmit one or more commands in the communications 668 to the mobile communication device 121. The one or more commands notify the mobile communication device 121 to increase a magnitude of the wireless power of transmitting communications 102 from the mobile communication device 121 to the wireless base station 131 from a wireless transmit power level of P2 (associated with the allocated 20 megahertz bandwidth) to a wireless transmit power level of P1 (associated with the allocated 40 megahertz bandwidth), where P1 is less than P2.

In other words, in response to the reallocation of wireless channel #3 and wireless channel #4 increasing the bandwidth of 40 megahertz, the communication management resource 140 and corresponding wireless base station 131 notify the mobile communication device 121 to transmit communications 102 over the wireless channels 1, #2, #3, and #4, at the higher power level P1.

In response to receiving the communications 668, the mobile communication device 121 decreases a respective power of transmitting communications 102 (at the 40 megahertz bandwidth) over the wireless communication link 127-1 to the wireless base station 131.

Via communications 670, the mobile communication device 121 notifies the wireless base station 131 and corresponding communication management resource 140 of the decrease in power associated with the mobile communication device 131 transmitting in the uplink direction to the wireless base station 131. After receiving the acknowledgment that the mobile communication device 121 decreased the wireless power level to power level P1, the wireless base station 131 notifies the mobile communication device 121 that the wireless base station 131 receives the acknowledgment of the mobile communication device 121 decreasing its power level to power level P1.

As further shown, the wireless base station 131 and corresponding communication management resource 140 can be configured to transmit communications 675 to the performance monitor 144. In one example, the communications 675 include a request for review of performance information associated with the mobile communication device 121 transmitting at the new power level PI using wireless channels #1, #2, #3, and #4.

In response to receiving the request in communications 675, the performance monitor 144 transmits communications 680 to the wireless base station 131 and corresponding communication management resource 140. In one example, the communications 680 include a performance analysis of the mobile communication device 121 communicating with the wireless base station 131.

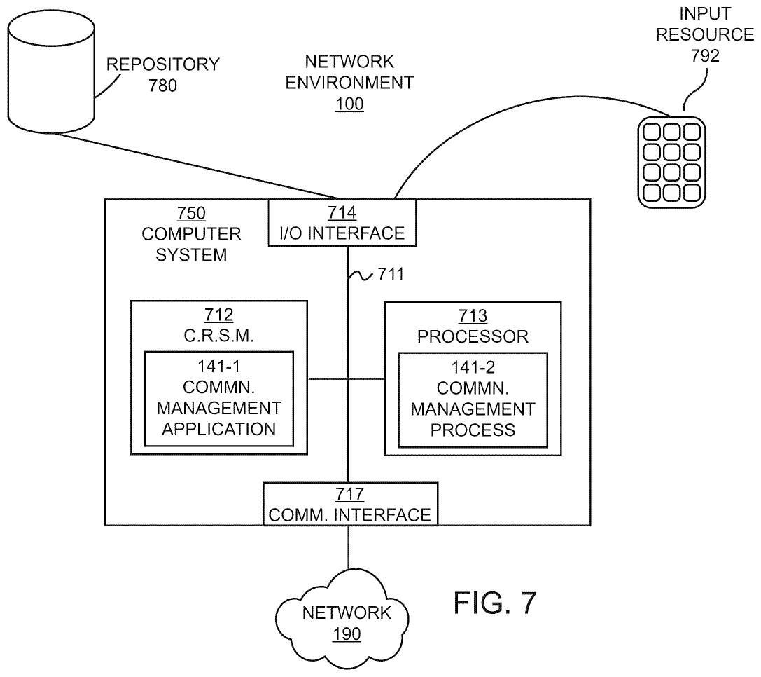

FIG. 7 is an example block diagram of a computer system for implementing any of the operations as previously discussed according to examples herein.

Note that any of the resources (such as communication management resource 140, communication device 121, allocation management resource 141, server 143, performance engine 145, etc.) as discussed herein can be configured to include computer processor hardware and/or corresponding executable instructions to carry out the different operations as discussed herein.

For example, as shown, computer system 750 of the present example includes interconnect 711 coupling computer readable storage media 712 such as a non-transitory type of media, or computer readable storage hardware (which can be any suitable type of resource in which digital information can be stored and or retrieved), a processor 713 (computer processor hardware), I/O interface 714, and a communications interface 717.

I/O interface(s) 714 supports connectivity to repository 780 and input resource 792.

Computer readable storage medium 712 such as computer readable hardware can be any hardware storage device such as memory, optical storage, hard drive, floppy disk, etc. In one example, the computer readable storage medium 712 stores instructions and/or data.

As shown, computer readable storage media 712 can be encoded with communication management application 140-1 in a respective wireless station to carry out any of the operations as discussed herein.

During operation of one example, processor 713 accesses computer readable storage media 712 via the use of interconnect 711 in order to launch, run, execute, interpret or otherwise perform the instructions in management application 140-1 stored on computer readable storage medium 712. Execution of the communication management application 140-1 produces communication management process 140-2 to carry out any of the operations and/or processes as discussed herein.

Those skilled in the art will understand that the computer system 750 can include other processes and/or software and hardware components, such as an operating system that controls allocation and use of hardware resources to execute the management application 140-1.

In accordance with different examples, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 750 may reside at any location or can be included in any suitable resource in any network environment to implement functionality as discussed herein.

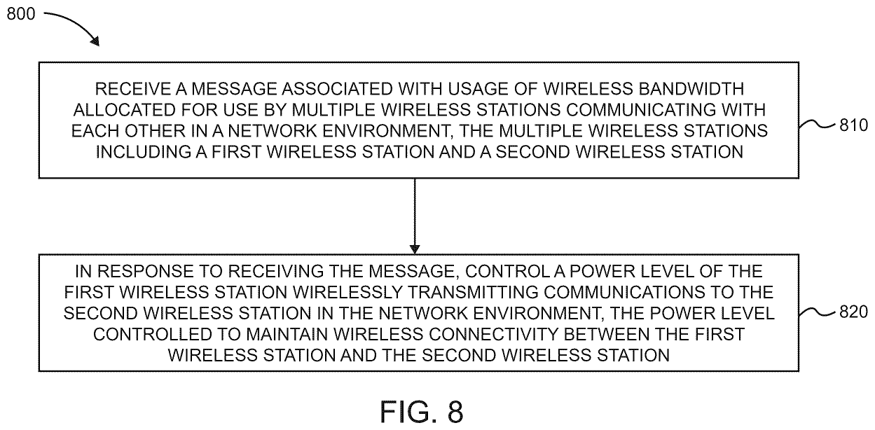

Functionality supported by the different resources will now be discussed via flowchart 800 in FIG. 8. Note that the steps in the flowchart below can be executed in any suitable order.

FIG. 8 is a flowchart 800 illustrating an example method according to examples herein. Note that there will be some overlap with respect to concepts as discussed above.

In processing operation 810, the communication management resource 140 receives a message such as any of messages 183, 605, 655, etc., associated with wireless bandwidth allocated for use by multiple wireless stations (such as wireless base station 131, mobile communication device 121, etc.) communicating with each other in a network environment 100.

In processing operation 820, in response to receiving the resource allocation message, the communication management resource 140 controls a power level of the first wireless station (such as mobile communication device 121 or other suitable entity) wirelessly transmitting communications to the wireless base station 131 (second wireless station) in the network environment. In one example, the communication management resource 140 controls the power level of the mobile communication device 121 in an uplink direction to maintain wireless connectivity between the first wireless station and the second wireless station during a condition such as a reduction in wireless bandwidth allocated by the allocation management resource 141 or other suitable entity.

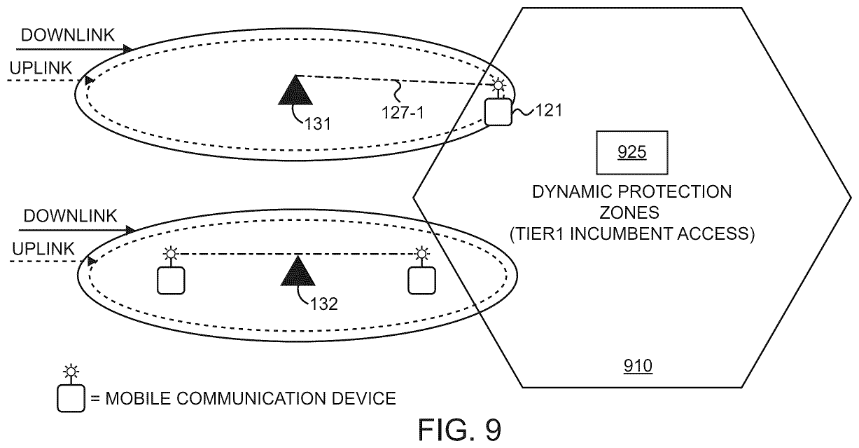

FIG. 9 is an example diagram illustrating detection of wireless channel use in a protected zone as discussed herein.

In this example, assume that the monitor resource 142 or other suitable entity detects that the wireless connectivity (2-way wireless communications) between the wireless base station 131 and the mobile communication device 121 results in wireless interference in the protective geographical region 910. Assume that the geographical region 910 is a region in which a respective incumbent entity is protected from wireless interference by other wireless stations transmitting over one or more wireless channels used by the incumbent entity. The geographical region 910 may be protected because a respective incumbent entity 925 having higher priority rights than the wireless base station 131, wireless base station 132, communication device 121, etc., is presently communicating in the geographical region 910.

In response to detecting interference, the wireless base stations (131, 132, etc.) and corresponding communication devices will be controlled to reduce their respective wireless transmit power levels to reduce a respective coverage and corresponding interference footprint prior to complete termination of the wireless base stations using the wireless channel.

In other words, the monitor resource 142 or other suitable entity can be configured to detect occurrence of respective interference to the incumbent entity 925, the interference caused by the wireless base stations and mobile communication devices transmitting wireless signals in the network environment 100. In response to receiving notification of the interference, the wireless base station 131 and corresponding mobile communication device eventually may be required to discontinue or at least reduce power transmit associated with use of one or more allocated wireless channels. In one example, prior to complete termination of using the allocated wireless channels, the wireless base station 131 and corresponding mobile communication device 121 may temporarily reduce their respective wireless transmit power levels to reduce interference to the incumbent entity 925.

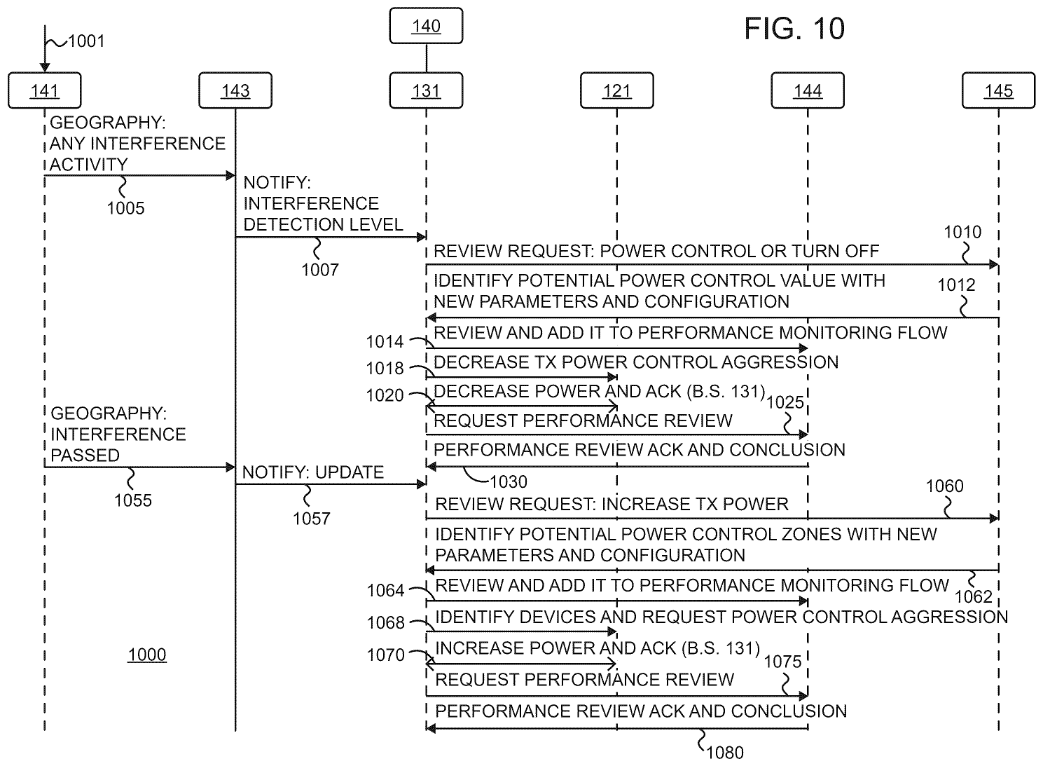

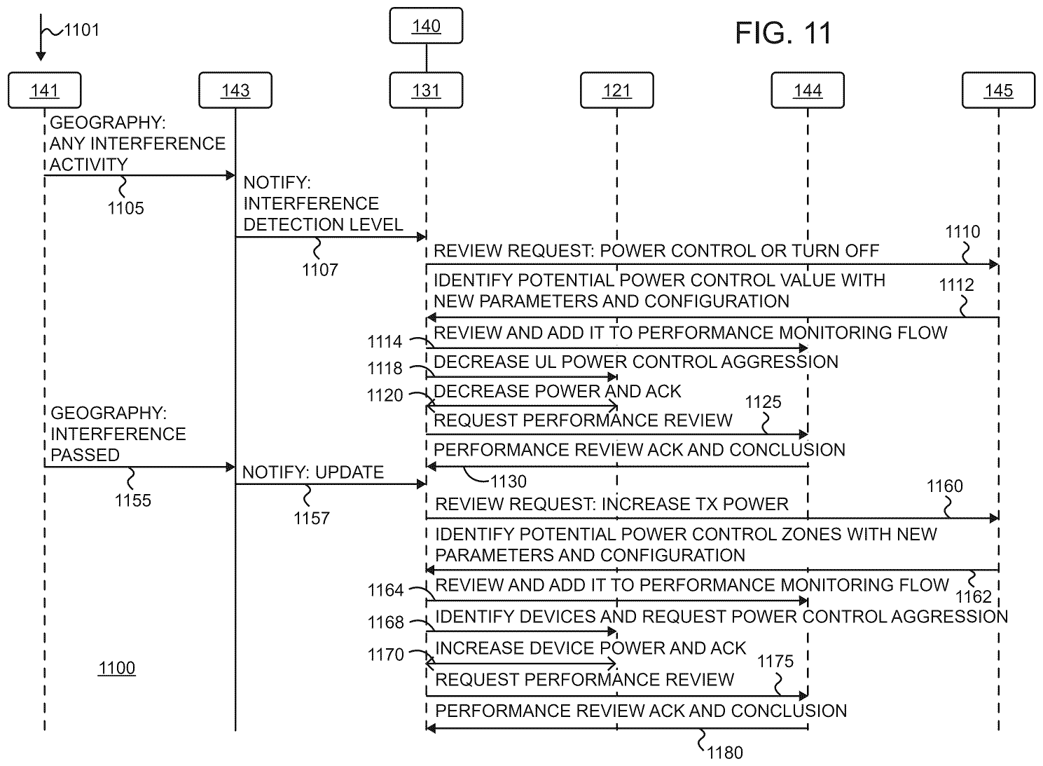

As further discussed below and as shown in FIGS. 10 and 11, techniques herein include decreasing a wireless transmit power of the wireless base station 131 and/or decreasing a wireless transmit power level of the mobile communication device 121 in response to detecting wireless interference in the geographical region 910.

FIG. 10 is an example diagram illustrating wireless power control of the base station in the downlink direction in response to detecting wireless channel interference as discussed herein.

In this example, the downlink power of transmitting communications from the wireless base station 131 to the mobile communication device 121 is controlled (adjusted) based on detection of interference in the network environment 100. The interference may occur for any reason such as use of wireless channels by an incumbent entity, use of wireless channels by other entities, etc.

More specifically, timing diagram 1000 in FIG. 10 illustrates downlink power control adjustments associated with the wireless base station 131 based upon detected wireless interference. In this example, assume that the wireless base station 131 and corresponding mobile communication device 121 are initially allocated use of 40 megahertz of wireless bandwidth such as including wireless channel #1, wireless channel #2, wireless channel #3, and wireless channel #4. The wireless base station 131 and the corresponding mobile communication device 121 use the allocated wireless channels to convey data in both directions between the wireless stations over the wireless communication link 127-1.

Assume further that the monitor resource 142 transmits the communications 1001 to the allocation management resource 140 in response to detecting that an entity (such as incumbent entity 925 or some other entity) in the network environment experiences wireless interference associated with wireless channel #3 and/or wireless channel #4 or any wireless channel. The communications 1001 can be configured to notify the allocation management resource that the entity is currently using wireless channel #3 and wireless channel #4 or experiencing the wireless interference.

Receipt of the communications 1001 regarding the detected interference (such as caused by the wireless base station 131 or mobile communication device 121 transmitting via wireless channel #3 or wireless channel #4 or other wireless channel) prompts the allocation management resource 141 or other suitable entity to notify the server 143 of the detected interference via communications 1005.

As further shown, in response to receiving the communications 1005 indicating the detected wireless interference such as associated with the wireless channel #3 or wireless channel #4 or other wireless channel, the server 143 transmits communications 1007 to the wireless base station 131 and corresponding communication management resource 140. The communications 1007 notify the wireless base station 131 and corresponding communication management resource 140 of the detected wireless interference (and potentially the corresponding interference detection level) associated with wireless channel #3 and wireless channel #4. In such an instance, the wireless base station 131 and corresponding communication management resource 140 are aware of the level of wireless interference they cause to another entity.

In addition to the notification of wireless interference, the communications 1007 may indicate that the wireless channel #3 and wireless channel #4 are being revoked while wireless channel #1 and wireless channel #2 are still allocated for use by the wireless base station 131 and mobile communication device 121.

Prior to discontinuing (vacating) use of the wireless channel #3 and the wireless channel #4, the communication management resource 140 can be configured to reduce a respective wireless power level of the wireless base station 131 communicating with the communication device 121. The temporary reduction in transit power by the wireless base station 131 prior to the complete termination of using the wireless channel #3 and/or the wireless channel #4 reduces wireless interference caused by the wireless base station 131 and communication device 121 to the incumbent entity 925 or other entity in the network environment.

In response to receiving communications 1007 such as indicating the wireless interference and potentially suspension (that is, revocation) of use of wireless channel #3 and wireless channel #4, the wireless base station 131 transmits communications 1010 to the prediction engine 145 implementing a respective predictive analytics function. In this example, the communications 1010 include a request to review power control of the wireless station 131, which may include the revocation of the wireless channels #3 and #4.

In response to receiving the communications 1010 indicating the power control review request, the prediction engine 145 generates and transmits communications 1012 to the wireless base station 131 and corresponding communication management resource 140. The communications 1012 can be configured to indicate potential power control values with new parameters and configuration of the wireless base station 131.

The communication management resource 140 reviews the power control information received in communications 1012. In response to receiving the communications 1012, the communication management resource 140 transmits communications 1014 to the performance monitor 144. The transmitted communications 1014 notify the performance monitor 144 to monitor performance associated with the wireless base station 131 communicating with the mobile communication device 121.

In response to receiving the communications 1014, the performance monitor 144 monitors communications over the communication link 127-1 between the mobile communication device 121 and the wireless base station 131. Based on the monitoring, the performance monitor 144 produces performance information associated with the communications conveyed between the wireless base station 131 and the mobile communication device 121. The performance information indicates the quality of the wireless communication link 127-1 and how well it supports conveyance of data.

As further shown, the wireless base station 131 and corresponding communication management resource 140 transmit communications 1018 to the mobile communication device 121. The communications 1018 indicate a decrease in transmit power control by the wireless base station 131.

In response to receiving the communications 1018, the mobile communication device 121 transmits communications 1020 to the communication management resource and corresponding wireless base station 131.

As further shown, the wireless base station 131 and corresponding communication management resource 140 can be configured to transmit communications 1025 to the performance monitor 144. In one example, the communications 1025 include a request for review of performance information associated with communications between the mobile communication device 121 and/or wireless base station 131.

In response to receiving the performance request in communications 1025, the performance monitor 144 transmits communications 1030 to the wireless base station 131 and corresponding communication management resource 140. In one example, the communications include a performance analysis and/or performance review information associated with the mobile communication device 121 wirelessly communicating with the wireless base station 131 or vice versa.

As previously discussed, in addition to notification of interference, the notification from the allocation management resource 141 may indicate to terminate use of the wireless channel #3 and wireless channel #4. Sometime (such as one minute or some other value) after implementing the transmit power reduction associated with the mobile communication device 121 transmitting in the uplink direction, both the mobile communication device 121 and the wireless base station 131 can be configured to discontinue using the wireless channel #3 and wireless channel #4 so that there is no interference with the incumbent entity 925 or any other entity in the network environment 100.

In response to receiving the communications 1001 (such as indicating no interference to the entity in the network environment), the allocation management resource 141 transmits communications 1055 to the server 143. The communications 1055 can be configured to notify the server 143 that there is no longer interference in the network environment caused by the wireless base station 131 and/or the mobile communication device 121.

As further shown, in response to receiving the communications 1055 indicating non-detection (no longer detection) of the wireless interference, the server resource 143 transmits communications 1057 to the wireless base station 131 and corresponding communication management resource 140.

In addition to the notification of no wireless interference, the communications 1057 may indicate that the wireless channel #3 and wireless channel #4 are being reallocated while wireless channel #1 and wireless channel #2 are still allocated for use by the wireless base station 131 and mobile communication device 121. In response to receiving communications 1057 such as indicating the no wireless interference and potentially reallocation of wireless channel #3 and wireless channel #4, the wireless base station 131 transmits communications 1060 to the prediction engine 145 implementing a respective predictive analytics function. In this example, the communications 1060 include a request to review the increase of transmit power by the wireless base station 131.

In response to receiving the communications 1060 indicating the power control review request, the prediction engine 145 generates and transmits communications 1062 to the wireless base station 131 and corresponding communication management resource 140. The communications 1062 can be configured to indicate potential power control zones with new parameters and configuration of the wireless base station 131.

The communication management resource 140 reviews the power control information received in communications 1062. In response to receiving the communications 1062, the communication management resource 140 transmits communications 1064 to the performance monitor 144. The transmitted communications 1064 notify the performance monitor 144 to monitor performance associated with the wireless base station 131 communicating with the mobile communication device 121.

In response to receiving the communications 1064, the performance monitor 144 monitors communications between the mobile communication device 121 and the wireless base station 131. Based on the monitoring, the performance monitor 144 produces performance information associated with the communications conveyed between the wireless base station 131 and the mobile communication device 121. The performance information indicates the quality of the wireless communication link 127-1 and how well it supports conveyance of data.

As further shown, the wireless base station 131 and corresponding communication management resource 140 transmit communications 1068 to the mobile communication device 121. The communications 1068 indicate an increase in wireless transmit power control by the wireless base station 131.

In response to receiving the communications 1068, the mobile communication device 121 transmits communications 1070 to the communication management resource and corresponding wireless base station 131.

As further shown, the wireless base station 131 and corresponding communication management resource 140 can be configured to transmit communications 1075 to the performance monitor 144. In one example, the communications 1075 include a request for review of performance information associated with the mobile communication device 121 and/or wireless base station 131.

In response to receiving the performance request in communications 1075, the performance monitor 144 transmits communications 1080 to the wireless base station 131 and corresponding communication management resource 140. In one example, the communications include a performance analysis and/or performance review information associated with the mobile communication device 121 wirelessly communicating with the wireless base station 131 or vice versa.

FIG. 11 is an example diagram illustrating wireless power control of a mobile communication device in an uplink direction in response to detecting wireless channel interference as discussed herein.

More specifically, timing diagram 1100 in FIG. 11 illustrates uplink power control adjustments based upon detecting wireless interference. In this example, assume that the wireless base station 131 and corresponding mobile communication device 121 are initially allocated use of 40 megahertz of wireless bandwidth such as including wireless channel #1, wireless channel #2, wireless channel #3, and wireless channel #4. The wireless base station 131 and the corresponding mobile communication device 121 use the allocated wireless channels to convey data in both directions between the wireless stations.

Assume further that the monitored resource 142 transmits the communications 1101 to the allocation management resource 140 in response to detecting that an incumbent entity or other entity in the network environment 100 experiences wireless interference associated with use of wireless channel #3 and wireless channel #4. The communications 1101 can be configured to indicate that the incumbent entity is currently using wireless channel #3 and wireless channel #4.

Receipt of the communications 1101 regarding the interference prompts the allocation management resource 141 or other suitable entity to notify the server 143 of the detected interference via communications 1105.

As further shown, in response to receiving the communications 1105 indicating detected wireless interference, the server 143 transmits communications 1107 to the wireless base station 131 and corresponding communication management resource 140. The communications 1107 notify the wireless base station 131 and corresponding communication management resource 140 of the detected wireless interference associated with wireless channel #3 and wireless channel #4 or other wireless channels. In addition to the notification of wireless interference, the communications 1107 may indicate that the wireless channel #3 and wireless channel #4 are being revoked while wireless channel #1 and wireless channel #2 are still allocated for use by the wireless base station 131 and mobile communication device 121.

Prior to discontinuing use of the wireless channel #3 and the wireless channel #4, the communication management resource 140 can be configured to reduce a respective wireless power level of the communication device 121 communicating with the wireless base station 131. The temporary reduction in transit power by the communication device 121 prior to the complete termination of using the wireless channel #3 and the wireless channel #4 reduces wireless interference caused by the wireless base station 131 and communication device 121 to the incumbent entity 125.

In response to receiving communications 1107 such as indicating the wireless interference and potentially indicating suspension (that is, revocation) of use of wireless channel #3 and wireless channel 4, the wireless base station 131 transmits communications 1110 to the prediction engine 145 implementing a respective predictive analytics function. The communications 1107 include a request to review power control or turn off of the communication device 121 using the wireless channels #3 and #4.

In response to receiving the communications 1110 indicating notice of power control and review request, the prediction engine 145 generates and transmits communications 1112 to the wireless base station 131 and corresponding communication management resource 140.

The wireless base station 131 and corresponding communication management resource 140 determine and review the potential power control value and new parameters and configuration information as specified by the communications 1112.

As further discussed below, because the mobile communication device 121 resides in the region of wireless coverage 910, via communications 1118, the wireless base station 131 and corresponding communication management resource 140 notify the mobile communication device 121 to decrease its power level when wirelessly transmitting signals over the wireless communication link 127-1 to the wireless base 131.

As further shown, the wireless base station 131 and corresponding communication management resource 140 transmit communications 1114 to the performance monitor 144 after determining that the mobile communication device 121 resides in the region of wireless coverage 910.

In response to receiving the communications 1114, the performance monitor 144 monitors communications between the mobile communication device 121 and the wireless base station 131. Based on the monitoring, the performance monitor 144 produces performance information associated with the communications conveyed between the wireless base station 131 and the mobile communication device 121. The performance information indicates the quality of the wireless communication link 127-1 and how well it supports conveyance of data.

As further shown, the wireless base station 131 and corresponding communication management resource 140 transmit one or more commands in the communications 1118 to the mobile communication device 121. The one or more commands notify the mobile communication device 121 to decrease a magnitude of the wireless power of transmitting communications 102 in the uplink from the mobile communication device 121 to the wireless base station 131.

In other words, in response to the wireless interference as detected in channel #3 and wireless channel #4, the communication management resource 140 and corresponding wireless base station 131 notify the mobile communication device 121 to transmit for the subsequent communications 102 over the wireless channels the #3 and #4 at the lower power level to reduce interference caused to the incumbent entity or other entity in the network environment 100.

In response to receiving the communications 1118, the mobile communication device 121 decreases a respective power of transmitting communications 102 (using wireless channel #3 and wireless channel #4) over the wireless communication link 127-1 to the wireless base station 131.

Further, via communications 1120, the mobile communication device 121 notifies the wireless base station 131 and corresponding communication management resource 140 of the decrease in power associated with the mobile communication device 131 transmitting communications 102 in the uplink direction to the wireless base station 131. After receiving the acknowledgment that the mobile communication device 121 decreased the wireless power level to power level, the wireless base station 131 can be configured to notify the mobile communication device 121 that the wireless base station 131 received the power change acknowledgment of the mobile communication device 121 decreasing its power level.

As further shown, the wireless base station 131 and corresponding communication management resource 140 can be configured to transmit communications 1125 to the performance monitor 144. In one example, the communications 1125 include a request for review of performance information associated with the mobile communication device 121.

In response to receiving the request in communications 1125, the performance monitor 144 transmits communications 1130 to the wireless base station 131 and corresponding communication management resource 140. In one example, the communications include a performance analysis and/or performance information associated with the mobile communication device 121 wirelessly communicating with the wireless base station 131.

As previously discussed, the notification from the allocation management resource 141 may indicate to terminate use of the wireless channel #3 and wireless channel #4. Sometime (such as one minute or some other value) after implementing the transmit power reduction associated with the mobile communication device 121 transmitting in the uplink direction, both the mobile communication device 121 and the wireless base station 131 may discontinue using the wireless channel #3 and wireless channel #4 so that there is no interference with the incumbent entity 925.

Eventually, the allocation management resource 141 detects that the incumbent entity 925 or other entity no longer experiences wireless interference. As previously discussed, the wireless base station 131 and corresponding mobile communication device 121 were allocated use of 20 megahertz of wireless bandwidth such as including wireless channel #1, and wireless channel #2.

In response to receiving the communications 1101 (such as indicating no interference to the entity in the network environment), the allocation management resource 141 transmits communications 1155 to the server 143. The communications 1155 can be configured to notify the server 143 that there is no longer interference in the network environment caused by the wireless base station 131 and/or the mobile communication device 121.

As further shown, in response to receiving the communications 1155 indicating non-detection (no longer detection) of the wireless interference, the server resource 143 transmits communications 1157 to the wireless base station 131 and corresponding communication management resource 140.

In addition to the notification of no wireless interference, the communications 1157 may indicate that the wireless channel #3 and wireless channel #4 are being reallocated while wireless channel #1 and wireless channel #2 are still allocated for use by the wireless base station 131 and mobile communication device 121.

In response to receiving communications 1157 such as indicating the no wireless interference and potentially reallocation of wireless channel #3 and wireless channel #4, the wireless base station 131 transmits communications 1160 to the prediction engine 145 implementing a respective predictive analytics function. In this example, the communications 1160 include a request to review the increase of transmit power by the wireless base station 131.

In response to receiving the communications 1160 indicating the power control review request such as increase in wireless transmit power associated with the communication device 121, the prediction engine 145 generates and transmits communications 1162 to the wireless base station 131 and corresponding communication management resource 140. The communications 1162 can be configured to indicate potential power control zones with new parameters and configuration of the wireless base station 131.

The communication management resource 140 reviews the power control information and potential power control zones associated with new parameters and configuration received in communications 1162. In response to receiving the communications 1162, the communication management resource 140 transmits communications 1164 to the performance monitor 144. The transmitted communications 1164 notify the performance monitor 144 to monitor performance associated with the wireless base station 131 communicating with the mobile communication device 121.

In response to receiving the communications 1164, the performance monitor 144 monitors communications between the mobile communication device 121 and the wireless base station 131. Based on the monitoring, the performance monitor 144 produces performance information associated with the communications conveyed between the wireless base station 131 and the mobile communication device 121. The performance information indicates the quality of the wireless communication link 127-1 and how well it supports conveyance of data.

As further shown, the wireless base station 131 and corresponding communication management resource 140 transmit communications 1168 to the mobile communication device 121. The communications 1168 indicate an increase in wireless transmit power control by the wireless base station 131.

In response to receiving the communications 1168, the mobile communication device 121 transmits communications 1170 at a higher power level to the communication management resource and corresponding wireless base station 131.

As further shown, the wireless base station 131 and corresponding communication management resource 140 can be configured to transmit communications 1175 to the performance monitor 144. In one example, the communications 1175 include a request for review of performance information associated with the mobile communication device 121 and/or wireless base station 131.

In response to receiving the performance request in communications 1175, the performance monitor 144 transmits communications 1180 to the wireless base station 131 and corresponding communication management resource 140. In one example, the communications include a performance analysis and/or performance review information associated with the mobile communication device 121 wirelessly communicating with the wireless base station 131 or vice versa.

Thus, as previously discussed, the wireless transmission power adjustment in the uplink associated with the communication device 121 or the wireless transmission power adjustment downlink associated with wireless base station 131 reduces wireless interference with the incumbent entity prior to the wireless base station 131 and the communication device 121 completely terminating use of wireless channel #3 wireless channel #4.

Note again that techniques herein are well suited to provide improved wireless connectivity amongst wireless stations. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this example has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

We claim:

1. A method comprising:
receiving a message associated with usage of wireless bandwidth allocated to multiple wireless stations communicating with each other in a network environment, the multiple wireless stations including a first wireless station and a second wireless station; and
in response to receiving the message, controlling a power level of the first wireless station wirelessly transmitting communications to the second wireless station in the network environment, the power level controlled to maintain wireless connectivity between the first wireless station and the second wireless station.

2. The method as in claim 1, wherein the message is a control notification indicating reduction in a magnitude of the wireless bandwidth allocated for use by the multiple wireless stations in the network environment.

3. The method as in claim 2, wherein controlling the power level of the first wireless station includes:
transmitting a control command from the second wireless station to the first wireless station, the transmitted control command notifying the first wireless station to increase the power level of the first wireless station wirelessly transmitting communications to the first wireless station in response to the reduction in the wireless bandwidth.

4. The method as in claim 3, wherein the second wireless station is a wireless base station; and
wherein first wireless station is a mobile communication device in communication with the wireless base station via the wireless connectivity.

5. The method as in claim 1, wherein controlling the power level of the first wireless station occurs in response to detecting a condition in which the first wireless station resides at an edge of a region of wireless coverage supported by the second wireless station.

6. The method as in claim 5, wherein the message indicates reduced wireless bandwidth allocated for use by the multiple wireless stations; and
wherein controlling the power level of the first wireless station includes increasing a magnitude of the power level of the first wireless station wirelessly transmitting the communications to the second wireless station, the increased magnitude ensuring that the wirelessly transmitted communications from the first wireless station are received by the second wireless station.

7. The method as in claim 1, wherein controlling the power level of the first wireless station wirelessly transmitting the communications includes:
receiving feedback indicating a quality of wireless messages conveyed between the first wireless station and the second wireless station; and
via commands communicated from the second wireless station to the first wireless station, iteratively controlling the power level of the first wireless station wirelessly transmitting the communications to the second wireless station based on the feedback.

8. The method as in claim 1, wherein the message indicates detection of wireless interference associated with use of the wireless bandwidth allocated for use by the multiple wireless stations.

9. The method as in claim 1, wherein the message is a control notification indicating an increase in the wireless bandwidth allocated for use by the multiple wireless stations in the network environment.

10. The method as in claim 9, wherein controlling the power level of the first wireless station includes:
transmitting a control command from the second wireless station to the first wireless station, the transmitted control command notifying the first wireless station to decrease the power level of the first wireless station wirelessly transmitting communications to the first wireless station in response to the increase in the wireless bandwidth.

11. The method as in claim 1, wherein the message indicates detection of wireless interference to an entity having higher priority rights associated with use of the wireless bandwidth allocated to the multiple wireless stations.

12. The method as in claim 11, wherein controlling the power level of the first wireless station includes reducing a magnitude of the power level in response to receiving the message;
wherein transmission of the communications from the first wireless station to the second wireless station at the reduced magnitude of power level is sufficiently high to maintain the wireless connectivity between the first wireless station and the second wireless station; and
wherein transmission of the communications from the first wireless station to the second wireless station at the reduced magnitude of power level reduces wireless interference to the entity having the higher priority rights.

13. The method as in claim 12, wherein the first wireless station is a wireless base station; and
wherein the second wireless station is a first mobile communication device, the first mobile communication device being one of multiple mobile communication devices in wireless communication with the wireless base station.

14. A system comprising:
communication management hardware operative to:
receive a message associated with usage of wireless bandwidth allocated to multiple wireless stations communicating with each other in a network environment, the multiple wireless stations including a first wireless station and a second wireless station; and
in response to receiving the message, control a power level of the first wireless station wirelessly transmitting communications to the second wireless station in the network environment, the power level controlled to maintain wireless connectivity between the first wireless station and the second wireless station.

15. The system as in claim 14, wherein the message is a control notification indicating reduction in a magnitude of the wireless bandwidth allocated for use by the multiple wireless stations in the network environment.

16. The system as in claim 15, wherein the communication manager hardware is further operative to:
transmit a control command from the second wireless station to the first wireless station, the transmitted control command notifying the first wireless station to increase the power level of the first wireless station wirelessly transmitting communications to the first wireless station in response to the reduction in the wireless bandwidth.

17. The system as in claim 16, wherein the second wireless station is a wireless base station; and
wherein first wireless station is a mobile communication device in communication with the wireless base station via the wireless connectivity.

18. The system as in claim 14, wherein controlling the power level of the first wireless station occurs in response to detecting a condition in which the first wireless station resides at an edge of a region of wireless coverage supported by the second wireless station.

19. The system as in claim 18, wherein the message indicates reduced wireless bandwidth allocated for use by the multiple wireless stations; and
wherein the communication management hardware is further operative to increase a magnitude of the power level of the first wireless station wirelessly transmitting the communications to the second wireless station, the increased magnitude ensuring that the wirelessly transmitted communications from the first wireless station are received by the second wireless station.

20. The system as in claim 14, wherein the communication manager hardware is further operative to:
receive feedback indicating a quality of wireless messages conveyed between the first wireless station and the second wireless station; and
via commands communicated from the second wireless station to the first wireless station, iteratively control the power level of the first wireless station wirelessly transmitting the communications to the second wireless station based on the feedback.

21. The system as in claim 14, wherein the message indicates detection of wireless interference associated with use of the wireless bandwidth allocated to the multiple wireless stations.

22. The system as in claim 14, wherein the message is a control notification indicating an increase in the wireless bandwidth allocated for use by the multiple wireless stations in the network environment.

23. The system as in claim 14, wherein the communication manager hardware is further operative to:
transmit a control command from the second wireless station to the first wireless station, the transmitted control command notifying the first wireless station to decrease the power level of the first wireless station wirelessly transmitting communications to the first wireless station in response to the increase in the wireless bandwidth.

24. Computer-readable storage hardware having instructions stored thereon, the instructions, when carried out by computer processor hardware, cause the computer processor hardware to:
receive a message associated with usage of wireless bandwidth allocated to multiple wireless stations communicating with each other in a network environment, the multiple wireless stations including a first wireless station and a second wireless station; and
in response to receiving the message, control a power level of the first wireless station wirelessly transmitting communications to the second wireless station in the network environment, the power level controlled to maintain wireless connectivity between the first wireless station and the second wireless station.
